(19) United States
(12) Patent Application Publication
(10) Pub. No.: US 2018/0029438 A1
(43) Pub. Date: Feb. 1, 2018

(54) DEVICE FOR HEAT TRANSFER AND METHOD FOR OPERATING THE DEVICE

(71) Applicant: Hanon Systems, Daejeon (KR)

(72) Inventors: Christoph Bara, Köln (DE); Marc Graaf, Krefeld (DE); Navid Durrani, Kerpen (DE); Felix Girmscheid, Köln (DE)

(21) Appl. No.: 15/656,416

(22) Filed: Jul. 21, 2017

(30) Foreign Application Priority Data
Jul. 27, 2016 (DE) 10 2016 113 801.0
Jul. 5, 2017 (DE) 10 2017 114 993.7

(51) Int. Cl. B60H 1/00; B60H 1/22

(52) U.S. Cl. CPC B60H 1/00335; B60H 1/22; B60H 2001/2271

(57) ABSTRACT

A device for the heat exchange between a first fluid and a second fluid, in particular for a refrigerant circuit of an air conditioning system for treating the incoming air of a passenger compartment of a motor vehicle comprising at least one first row and one second row which are each implemented of tubes for conducting the first fluid, the tubes being disposed in parallel and spaced apart from one another and, with respect to one another, such that the second fluid flows sequentially around the rows in a direction of flow. The tubes are disposed such that second can flow in parallel around the tubes. Rows are each implemented with an inlet and an outlet for the first fluid and spaced apart from one another. Between rows a gap is implemented in each instance. A method for operating the device is also provided.

The invention relates to a device for heat exchange between a first fluid and a second fluid, in particular a heat exchanger for a refrigerant circuit of an air conditioning system of a motor vehicle for the transfer of heat from the refrigerant to air to be supplied to a passenger compartment of the motor vehicle. The device comprises at least two rows, each of which being implemented of tubes, disposed in parallel and spaced apart for conducting the first fluid, and disposed with respect to one another such that the second fluid flows sequentially around the rows. The tubes are disposed in parallel such that the second fluid can flow around them. The invention relates furthermore to a method for operating the device for heat exchange between a first fluid and a second fluid in a refrigerant circuit of an air conditioning system of a motor vehicle.

In motor vehicles known in prior art the waste heat of the engine is utilized to heat the incoming air to the passenger compartment. The waste heat is transported by means of the coolant, circulated in the engine coolant circuit, to the air conditioning system and here transferred across the heat exchanger to the air flowing into the passenger compartment. In order to cover the total heat requirement of the passenger compartment, known systems with coolant-air heat exchangers that derive their heating capacity from the coolant circuit of an efficient combustion engine of the vehicle drive, at low ambient temperatures no longer achieve the level required for comfortable heating of the passenger compartment. The same applies to systems in motor vehicles with hybrid drive.

If the total heat requirement of the passenger compartment can no longer be covered by means of the heat from the engine coolant circuit, auxiliary heating measures, such as electric resistance heaters or fuel heaters, are required. The more efficient feasibility of heating the incoming air for the passenger compartment is a heat pump with air as the heat source.

DE 10 2012 100 525 A1 discloses a refrigerant circuit of a motor vehicle for cooling, heating and dehumidifying the incoming air for the passenger compartment, with a cooling system circuit and a heat pump circuit. The refrigerant circuit is implemented with a compressor for compressing gaseous refrigerant from a lower pressure level to a higher pressure level, several heat exchangers as well as at least one evaporator, and at least one condenser/gas cooler as well as at least one expansion element.

During operation of the refrigerant circuit in heat pump mode, the gaseous refrigerant, heated due to the compression, flows from the compressor to a heat exchanger operated as a condenser/gas cooler, which is developed as a refrigerant-air heat exchanger and disposed within the air conditioner apparatus. Due to its function of heating the incoming air for the passenger compartment, the heat exchanger is also denoted as heat condenser/heat gas cooler. The condensation heat, or the deheating heat, of the refrigerant is transferred to the incoming air for the passenger compartment.

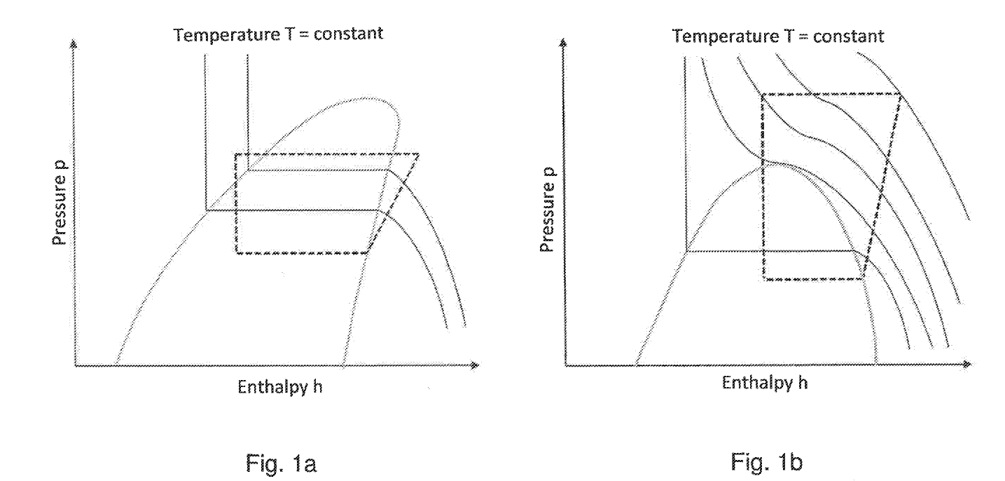

If, during subcritical operation of the refrigerant circuit, such as for example with the refrigerant R134a or at certain ambient conditions, the refrigerant is liquefied with carbon dioxide, the heat exchanger is referred to as condenser. FIG. 1a shows a pressure-enthalpy diagram for the operation of a refrigerant circuit in the subcritical range. A portion of the heat is transferred at constant temperature. During supercritical operation, or with supercritical heat output in the heat exchanger, the temperature of the refrigerant decreases steadily. The heat exchanger in this case is also referred to as gas cooler. Supercritical operation of the refrigerant circuit can occur under certain ambient conditions or operating modes of the refrigerant circuit, for example with the refrigerant carbon dioxide.

In a refrigerant circuit operated transcritically which, according to prior art for carbon dioxide, also referred to as R744, is utilized for treating the air of a passenger compartment, the heat is transferred from the refrigerant to the incoming air of the passenger compartment at a supercritical pressure level, with the pressure being greater than the critical pressure of the refrigerant. FIG. 1b shows a pressure-enthalpy diagram for the transcritical operation of a refrigerant circuit with a heat output in the supercritical range. In contrast to a subcritically operated refrigerant circuit, in which the temperature of the refrigerant during the condensation phase or the liquefaction stays essentially constant, during the supercritical heat output, or gas cooling, the temperature of the refrigerant decreases continuously, which is illustrated with the lines of constant temperatures.

A conventional heat exchanger operated as a heat condenser/heat gas cooler of a refrigerant circuit of an air conditioning system is developed as a refrigerant-air heat exchanger with at least one row or at least two successive rows, that is rows through which the refrigerant flows sequentially, with refrigerant lines disposed in parallel and with air grids, or fins, disposed transversely or perpendicularly to the refrigerant lines.

Herein the refrigerant flows singly or multiply in meander form through each row. The incoming air for the passenger compartment to be heated is conducted through the heat exchanger in cross-counterflow to the flow path of the refrigerant. Between the inlet and the outlet of the heat exchanger the air is herein heated by absorbing the heat of the refrigerant.

JP 2011 230655 A discloses an interior vehicle compartment heat exchanger operated as condenser of a refrigerant circuit and disposed within the flow path of the incoming air of the passenger compartment.

To increase the thermal efficiency of the heat exchanger, the heat exchanger is developed of two rows with refrigerant tubes disposed in parallel through which flows the refrigerant. The rows of the refrigerant tubes are disposed successively in a direction of air flow. The refrigerant is introduced into a first collector tube through an inlet and divided over the refrigerant tubes of the first row. After the refrigerant has flowed through the refrigerant tubes of the first row, it is mixed in a second collector tube and divided over the refrigerant tubes of the second row. After the refrigerant has flowed through the refrigerant tubes of the second row, it is mixed in a third collector tube and conducted through an outlet out of the heat exchanger. Reversing its direction of flow, the refrigerant herein flows in the second collector tube through the refrigerant tubes of the first and the second row, wherein the incoming air in the direction of flow acts first on the second row and subsequently on the first row.

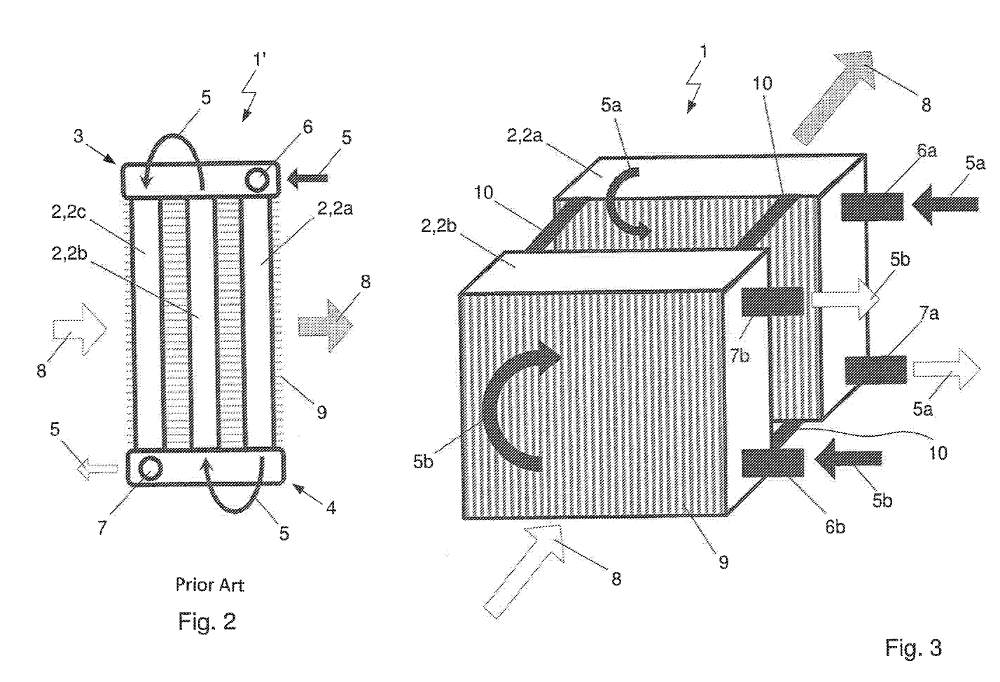

In FIG. 2 can be seen in top view a heat exchanger 1′ of prior art comprised of several rows, similar to the heat exchanger disclosed in JP 2011 230655 A.

The refrigerant-air heat exchanger 1′ is built of refrigerant tubes disposed in several rows 2 through and around which refrigerant and air, respectively, can flow in parallel in the particular row 2. The refrigerant, as well as also the air, flow sequentially through and respectively around each of the individual rows 2 of the refrigerant tubes.

Each of the refrigerant tubes extends between a first collector tube 3 and a second collector tube 4. The refrigerant flows in the direction of flow 5 through an inlet 6 into the first collector tube 3 and is subsequently divided over the refrigerant tubes of a first row 2a. After the refrigerant has flowed in parallel through the refrigerant tubes of the first row 2a, it is mixed in the second collector tube 4, changed in direction and divided over the refrigerant tubes of a second row 2b. The refrigerant flows back in the reverse direction to the flow through the refrigerant tubes of the first row 2a, through the refrigerant tubes of the second row 2b parallel to the first collector tube 3. The refrigerant is subsequently mixed in the first collector tube 3, its direction changed, and divided over the refrigerant tubes of a third row 2c. After the refrigerant, again in parallel, has flowed through the third row 2c, it is again mixed in the second collector tube 4 and through an outlet 7 conducted out of the heat exchanger 1′. The refrigerant herein flows each time with a change of direction through the refrigerant tubes of the first row 2a, the second row 2b and the third row 2c, with the incoming air flowing in the direction of flow 8 first around the refrigerant tubes of the third row 2c, subsequently of the second row 2b and then of the first row 2a. The heat exchanger 1′ is operated in cross-counterflow in view of the direction of flow 5 of the refrigerant and in the direction of flow 8 of the air.

The inlet 6 of the refrigerant is implemented on the first collector tube 3 while the outlet 7 of the refrigerant is located on the second collector tube 4.

The refrigerant tubes of each row 2a, 2b, 2c as well as also the refrigerant tubes of several rows 2a, 2b, 2c are thermally connected with one another across fins 9. By thermal connection is to be understood that the refrigerant tubes are connected such that they conduct heat.

Under transcritical operation of the refrigerant circuit, and therewith a heat emission of the refrigerant in the supercritical range, the temperature of the refrigerant decreases continuously from the inlet of the heat exchanger to its outlet. The temperature difference of the refrigerant between the inlet and the outlet occurring therein can have values of up to 140 K, especially when using carbon dioxide as the refrigerant. The large temperature difference of the refrigerant within the heat exchanger leads to highly nonhomogeneous temperature distributions of the air streaming out of the heat exchanger operated as a gas cooler. The difference between the maximum value and the minimum value of the outlet temperature of the air, also referred to as temperature spread, is conventionally in the range of 40 K to 70 K and thus outside of predetermined tolerances.

Operation of a heat exchanger from prior art as a gas cooler in the supercritical range of a refrigerant consequently leads to a very high and unacceptable temperature spread of the heated incoming air for the passenger compartment streaming out of the heat exchanger.

The problem addressed by the invention now comprises providing a device for heat exchange, in particular a refrigerant-air heat exchanger, which is suitable for operation as a gas cooler in the supercritical range of a refrigerant and which effects a minimal temperature spread of the air leaving the gas cooler. The device is to be of simple structure in order to incur only minimal operating costs, production costs and maintenance costs, as well as require minimal installation space.

Moreover, a method for operating the device is to be provided which ensures a minimal temperature spread of the air leaving the gas cooler.

The problem is resolved through the subject matters with the characteristics of the independent patent claims. Further developments are specified in the dependent patent claims.

The problem is resolved through a device according to the invention for the heat exchange between a first fluid and a second fluid. The device comprises at least a first row and a second row, each developed of tubes for conducting the first fluid disposed parallel and spaced apart with respect to one another. The tubes of each row are disposed such that the second fluid can flow around them in parallel. The rows are aligned with respect to one another such that the second fluid flows around the rows sequentially in the direction of flow.

According to the concept of the invention the rows are each implemented with an inlet and an outlet for the first fluid and are disposed uniformly spaced apart. Between each of the rows there is a gap.

According to a further development of the invention, the rows of the device are mechanically connected with one another across connection elements. The device, consequently, represents an integral component.

The connection elements are herein advantageously comprised of a material and with a heat-transferring cross-section area such that the thermal resistivity of a connection element is at least 10 K/W in order to prevent, or at least to minimize, the heat transfer through thermal conduction between the rows of the device.

The connection elements are preferably of a material, for example a synthetic material, with a coefficient of thermal conductivity of maximally 3 W/mK. In addition, or alternatively, each of the connection elements has advantageously a heat-transferring cross-section area of maximally 1.5 mm². The connection elements are herein disposed such that sufficient mechanical stability of the device is ensured with a minimal number of connection elements.

According to a preferred implementation of the invention, each row comprises a first collector tube as well as a second collector tube, wherein the tubes of each row extend in each case between the first collector tube and the second collector tube.

According to a first alternative implementation of the invention, the inlet as well as also the outlet for the first fluid are both implemented together on one of the collector tubes of the row.

According to a second alternative implementation of the invention, the inlet for the first fluid is disposed on the first collector tube and the outlet for the first fluid is disposed on the second collector tube of the row.

The tubes of the row are on an outer side thermally connected with one another across fins, with the fins of different rows being spaced apart from one another.

The advantageous implementation of the invention, in particular in view of the disposition of the rows with respect to each other as well as the implementation of the separate inlets and outlets of the rows for the first fluid, enables the use of the device according to the invention for the heat exchange between a first fluid and a second fluid in a refrigerant circuit of an air conditioning system to treat the incoming air of a passenger compartment of a motor vehicle, in particular with a refrigerant as the first fluid with a temperature variable on the flow path through the device. The heat is herein transferred between the refrigerant and the incoming air as the second fluid.

Of special advantage is the application of the device as a condenser/gas cooler of the refrigerant circuit with carbon dioxide as the refrigerant, and a transfer of the heat in the supercritical range of the refrigerant.

The problem is also resolved through a method according to the invention for operating the device for the heat exchange between a first fluid and a second fluid in a refrigerant circuit of an air conditioning system of a motor vehicle. Herein the refrigerant as the first fluid flows through the tubes of each row and air as the second fluid flows around the tubes of each row.

According to the concept, a mass flow of the refrigerant, also referred to as total mass flow of the refrigerant, is divided in partial mass flows over the rows of the device. The partial mass flows are conducted in parallel through the rows.

An advantageous implementation of the invention comprises that a direction of flow of a partial mass flow of the refrigerant conducted through a first row and a direction of flow of a partial mass flow of the refrigerant conducted through a second row, in particular with equal flow paths within the rows, are aligned opposite to one another.

The rows of the device are preferably acted upon by air sequentially following one direction of flow.

According to an advantageous implementation of the invention the mass flow of the refrigerant is divided into partial mass flows each between 0 and 100%. A ratio of the partial mass flow flowing through a first row to the total mass flow of the refrigerant is herein preferably in the range of 30% to 70%.

According to a further development of the invention, the device is operated with the direction of flow of the refrigerant and the direction of flow of air in a cross-counterflow principle,

In summary, the device according to the invention for the heat exchange between a first fluid and a second fluid, in particular the refrigerant-air heat exchanger of a refrigerant circuit of an air conditioning system for treating the incoming air of a passenger compartment of a motor vehicle comprises diverse advantages:
suitability for operation as a gas cooler in the supercritical range of the refrigerant,
enabling a minimal temperature spread of the air leaving the gas cooler, as well as
simple structure and therewith minimal operating costs, production costs and maintenance cost, as well as minimal installation space requirement.

Further details, characteristics and advantages of implementations of the invention are evident based on the following description of embodiment examples with reference to the associated drawing. Therein depict:

FIG. 1a: a pressure-enthalpy diagram for the operation of a refrigerant circuit in the subcritical range,

FIG. 1b: a pressure-enthalpy diagram for the transcritical operation of a refrigerant circuit with heat emission in the supercritical range,

FIG. 2: a multi-row refrigerant-air heat exchanger of prior art in top view, and

FIG. 3: a multi-row refrigerant-air heat exchanger according to the invention with indication of the directions of flow of the heat-transferring fluids.

In FIG. 3 is depicted a device 1 for heat transfer, in particular a multi-row heat exchanger 1 with indication of the directions of flow 5a, 5b, 8 of the heat-exchanging fluids.

The device 1, specifically implemented as a refrigerant-air heat exchanger, comprises tubes, not shown, disposed in several rows 2, in particular two rows 2a, 2b, aligned parallel to one another. The tubes, specifically implemented as refrigerant tubes, are herein flowed through in parallel in the particular row 2a, 2b, on the one hand by refrigerant as the first fluid and, on the other hand, in parallel flowed around by the air as the second fluid. Rows 2a, 2b, that is the refrigerant tubes of the individual rows 2a, 2b, are acted upon sequentially by air in the direction of flow 8. The air can herein be conducted first through the first row 2a and subsequently through the second row 2b, or first through the second row 2b and subsequently through the first row 2a.

According to an alternative embodiment, not shown, the device is implemented with more than two rows, which are disposed identically to the rows of device 1 of FIG. 3. The air herein flows advantageously in each instance according to the cross-counterflow principle with respect to the refrigerant through all rows, wherein the air flows either first into the first row or first into the last row.

A refrigerant mass flow circulating through a refrigerant circuit, comprising the device 1 as a component, is divided over the rows 2 such that one partial mass flow of the refrigerant each is conducted through each row. The refrigerant mass flow can herein be divided into partial mass flows between 0 and 100%.

In the embodiment according to FIG. 3 with two rows 2a, 2b, the ratio of the partial mass flow flowing through the first row 2a to the total mass flow of the refrigerant is preferably in the range of 30% to 70%. The ratio of the partial mass flow flowing through the second row 2b to the total mass flow of the refrigerant is therewith preferably in the range of 70% to 30%.

The refrigerant tubes of each row 2a, 2b extend each between a first collector tube, not shown, and a second collector tube, not shown. The refrigerant flows herein in each case in the direction of flow 5a, 5b through an inlet 6a, 6b into the first collector tube of each row 2a, 2b and is subsequently divided over a first group of refrigerant tubes of the row 2a, 2b. After the refrigerant has flowed in parallel through the refrigerant tubes of the first group of each row 2a, 2b, it is mixed in the second collector tube, its directional flow is changed and divided over a second group of refrigerant tubes. The refrigerant flows in the direction reversely to the flow through the first group of the refrigerant tubes in parallel through the second group of the refrigerant tubes back to the first collector tube. The refrigerant flows with a reversal of direction in dual flow through the first and the second group of the refrigerant tubes of rows 2a, 2b. The incoming air flows in the direction of flow 8 first around the refrigerant tubes of the second row 2b and subsequently around the refrigerant tubes of the first row 2a. The refrigerant-air heat exchanger 1 is operated in cross-counterflow with respect to the directions of flow 5a, 5b of the refrigerant and the direction of flow 8 of the air.

Inlets 6a, 6b and outlets 7a, 7b of the refrigerant are both implemented on the first collector tube of rows 2a, 2b and therewith on one side of the heat exchanger 1.

According to an alternative embodiment, the refrigerant flows in each instance through an inlet into the first collector tube of each row and is subsequently divided over the refrigerant tubes of the row. After the refrigerant has flowed in parallel through the refrigerant tubes of the row, it is mixed in the second collector tube and conducted through an outlet out of the heat exchanger. The refrigerant herein flows only in one direction and thus from a first side to a second side of the heat exchanger through the refrigerant tubes of the rows. The refrigerant-air heat exchanger is also operated in cross-counterflow with respect to the directions of flow of the refrigerant and also with respect to the direction of flow of the air. The inlets of the refrigerant are herein in each instance located on the first collector tube of each row while the outlets of the refrigerant are each implemented on the second collector tube of the rows. The inlets and the outlets of the refrigerant are either located on one side or on both sides of the heat exchanger.

According to a further alternative embodiment, the refrigerant flows with multiple direction reversals in the form of a meander and therewith with multi-flow through each row. Depending on the number of direction reversals, and therewith the number of flows, the inlets and the outlets of the refrigerant are disposed on the first collector tube and/or on the second collector tube, or on one side or both sides of the heat exchanger.

The direction of flow 5a of the refrigerant in the first row 2a and the direction of flow 5b of the refrigerant in the second row 2b, independently of the embodiment of the heat exchanger 1, are opposite to one another at identically implemented flow paths. The directions of flow 5a, 5b extend in opposite directions.

When the refrigerant in a row 2a, 2b, for example with or without direction reversal, flows essentially in the vertical direction from below upwardly, the refrigerant within the adjacently disposed row 2b, 2a flows with or without direction reversal essentially in the vertical direction from above downwardly.

When the refrigerant flows in a row, for example with or without direction reversal, essentially in the horizontal direction from right to left, the refrigerant within the adjacently disposed row flows with or without direction reversal essentially in the horizontal direction from left to right.

According to an alternative embodiment, not shown, the directions of flow of the refrigerant in the first row 2a and in the second row 2b, independently of the embodiment of the heat exchanger 1, at identically implemented flow paths, can also be disposed in the same direction. The directions of flow of the refrigerant within the rows 2a, 2b extend in parallel.

The inlets 6a, 6b and the outlets 7a, 7b are disposed with respect to each other depending on the desired direction of flow 5a, 5b of the refrigerant through the different rows 2a, 2b.

According to the embodiment of FIG. 3, the inlet 6a of the refrigerant of the first row 2a is above in the vertical direction and the inlet 6b of the refrigerant of the second row 2b is below in the vertical direction. The outlet 7a of the refrigerant of the first row 2a, furthermore, is disposed below in the vertical direction while outlet 7b of the refrigerant of the second row 2b is implemented above in the vertical direction.

According to an embodiment, not shown, the inlet of the refrigerant of the first row can be disposed below in the vertical direction and the inlet of the refrigerant of the second row can be disposed above in the vertical direction. The outlet of the refrigerant of the first row, furthermore, can be disposed above in the vertical direction while the outlet of the refrigerant of the second row can be implemented below in the vertical direction.

The inlet 6a, 6b and the outlet 7a, 7b of the refrigerant of each row 2a, 2b, can each be disposed on the same side or on opposite sides of the heat exchanger 1. The inlets 6a, 6b and the outlets 7a, 7b, respectively, of the refrigerant of rows 2a, 2b can each be implemented on the same side or on opposite sides of the heat exchanger 1.

The refrigerant tubes of each row 2a, 2b are thermally connected with one another via fins 9, wherein the refrigerant tubes are heat-conductingly coupled with one another. In comparison to a heat exchanger 1′ according to FIG. 2 known from prior art, the refrigerant tubes of the different rows 2a, 2b, however, are not connected with one another so as to conduct heat. The fins 9 of the different rows 2a, 2b are disposed spaced apart from one another. Between the fins 9 of the different rows 2a, 2b there is, in each instance, a gap.

Rows 2a, 2b of the heat exchanger 1 according to FIG. 3 are mechanically coupled with one another across connection elements 10 such that the heat exchanger 1 is implemented as an integral component. Between the rows 2a, 2b and in particular between the fins 9 of the different rows 2a, 2b, a gap is formed which is ensured to be of a certain dimension by means of the connection elements.

The connection elements 10, disposed between rows 2a, 2b and maintaining the spacing to the adjacently disposed rows 2a, 2b, have a high thermal resistivity in order to exclude or minimize the heat transfer through heat conduction, and therewith the heat flow, between rows 2a, 2b of the heat exchanger 1.

Each of the connection elements 10 has a thermal resistivity of minimally 10 K/W or a heat conductance value or a thermal transmittance value of maximally 0.1 W/K. The thermal resistivity is derived, inter alia, from the thermal conductivity or the coefficient of thermal conductivity and the heat-transferring cross-section area.

The connection elements 10 can herein be implemented of a material, in particular a synthetic material, with a very low coefficient of thermal conductivity, for example less than or equal to 3 W/mK.

In addition, or alternatively, the effective cross-section area of the connection elements 10 for heat conduction can be implemented to be minimal. If each connection element 10 has a heat-transferring cross-section area of maximally 1.5 mm², the connection elements 10 can also be implemented of a well heat-conducting material, that means of a material, for example of aluminum, with a coefficient of thermal conductivity greater than 3 W/mK. The device 1 herein has a minimal number of connection elements 10, for example four, with which sufficient mechanical stability of the device 1 is ensured.

### LIST OF REFERENCE NUMBERS

1, 1′ Device, heat exchanger, refrigerant-air heat exchanger

2 Row

2a First row

2b Second row

2c Third row

3 First collector tube

4 Second collector tube

5 Direction of flow refrigerant

5a Direction of flow refrigerant first row 2a

5b Direction of flow refrigerant second row 2b

6 Inlet refrigerant

6a Inlet refrigerant first row 2a

6b Inlet refrigerant second row 2b

7 Outlet refrigerant

7a Outlet refrigerant first row 2a

7b Outlet refrigerant second row 2b

8 Direction of flow air

9 Fins

10 Connection elements

1. A device for the heat exchange between a first fluid and a second fluid, comprising at least one first row and one second row which
are each implemented of tubes for conducting the first fluid and disposed in parallel and spaced apart, wherein the tubes are disposed such that the second fluid can flow around them in parallel, and
disposed such with respect to one another that the second fluid flows sequentially around the rows in a direction of flow,
wherein the rows
are each implemented with an inlet and an outlet for the first fluid and
are disposed spaced apart from one another, wherein between the rows in each instance a gap is implemented.

2. A device as in claim 1, wherein the rows are mechanically connected with one another across connection elements.

3. A device as in claim 2, wherein the connection elements are implemented of a material and with a heat-transferring cross-section area such that the thermal resistivity of a connection element is at least 10 K/W.

4. A device as in claim 2, wherein the connection elements are implemented of a material with a coefficient of thermal conductivity of maximally 3 W/mK.

5. A device as in claim 2, wherein each of the connection elements has a heat-transferring cross-section area of maximally 1.5 mm².

6. A device as in claim 1, wherein each row comprises a first collector tube as well as a second collector tube and the tubes of each row are in each instance implemented such that they extend between the first collector tube and the second collector tube.

7. A device as in claim 6, wherein the inlet and the outlet for the first fluid are implemented together on one of the collector tubes of the row.

8. A device as in claim 6, wherein the inlet for the first fluid is implemented on the first collector tube and the outlet for the first fluid is implemented on the second collector tube of the row.

9. A device as in claim 1, wherein the tubes of the row are implemented such that they are thermally connected with one another on an outer side across fins, wherein the fins of different rows are disposed spaced apart from one another.

10. An air conditioning system for treating the incoming air of a passenger compartment of a motor vehicle, wherein said system comprises a refrigerant circuit, and said refrigerant circuit comprises the device of claim 1.

11. An air condition system as in claim 10 wherein the device is a condenser/gas cooler of the refrigerant circuit, wherein the refrigerant is carbon dioxide and wherein transfer of heat is in the supercritical range of the refrigerant.

12. A method for operating a device for the heat exchange between a first fluid and a second fluid as in claim 1 in a refrigerant circuit of an air conditioning system of a motor vehicle, wherein through the tubes of each row flows the refrigerant as the first fluid and around which flows air as the second fluid, and wherein a mass flow of the refrigerant is divided into partial mass flows over the rows of the device and the partial mass flows are conducted in parallel through the rows.

13. A method as in claim 12, wherein a direction of flow of a partial mass flow of the refrigerant in a first row and a direction of flow of a partial mass flow of the refrigerant in a second row are aligned opposite to one another.

14. A method as in claim 12, wherein the rows of the device are sequentially acted upon by air in a direction of flow.

15. A method as in one of claims 12, wherein the mass flow of the refrigerant is divided into partial mass flows each between 0 and 100%.

16. A method as in claim 15, wherein a ratio of the partial mass flow flowing through a first row to the total mass flow of the refrigerant is in the range of 30% to 70%.

17. A method as in claim 12, wherein the device with the direction of flow of a refrigerant and the direction of flow of the air is operated along the principle of cross-counterflow.

18. A device as in claim 3, wherein the connection elements are implemented of a material with a coefficient of thermal conductivity of maximally 3 W/mK.

19. A device as in claim 2, wherein each row comprises a first collector tube as well as a second collector tube and the tubes of each row are in each instance implemented such that they extend between the first collector tube and the second collector tube.

20. A device as in claim 3, wherein each row comprises a first collector tube as well as a second collector tube and the tubes of each row are in each instance implemented such that they extend between the first collector tube and the second collector tube.
